(19) United States
(12) Patent Application Publication
(10) Pub. No.: US 2003/0160865 A1
(43) Pub. Date: Aug. 28, 2003

(54) Electronic endoscope apparatus including video-processor

(75) Inventor: Tadashi Takahashi, Saitama (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 10/373,084

(22) Filed: Feb. 26, 2003

(30) Foreign Application Priority Data
Feb. 27, 2002 (JP) P2002-051068

(51) Int. Cl. H04N 7/18

(52) U.S. Cl. 348/65; 348/75

(57) ABSTRACT

A video-processor in an electronic endoscope apparatus is connectable to a plurality of video-scopes. The video-processor has a memory that is capable of storing plural series of scope-data associated with a signal process, and an adjusted scope-data setter that sets manually adjusted scope-data that is modified specific scope-data in a selected series of scope-data corresponding to a selected video-scope. The video-processor also has an automatic adjustment scope-data setter that changes given scope-data that correspond to a recently connected video-scope, to automatically adjusted scope-data. The automatic adjustment scope-data setter calculates the automatically adjusted scope-data on the basis of at least one manually adjusted scope-data and at least one initial specific scope-data corresponding to the at least one manually adjusted scope-data.

### BACKGROUND OF THE INVENTION

1. Field of the Invention

The present invention relates to an electronic endoscope apparatus, which has a video-scope with an image sensor and a video-processor, for observing and operating on an internal organ. Especially, it relates to a data setting process that sets data associated with a signal process, in accordance with the characteristics of a connected video-scope.

2. Description of the Related Art

A scope-memory for storing a series of scope-data associated with the signal process, is provided in each video-scope. For example, R and B gain data for a white balance process, CCD gain data, and so on, are included in the series of data, and each value of the series of scope-data is set in accordance with the characteristics of the video-scope. When the video-scope is connected to a video-processor, the series of scope-data is read from the memory. Then, the signal process is performed in the video-processor on the basis of the read series of scope-data, and video signals are output to a monitor to display an observed portion on the monitor.

The required characteristics and performance of a video-scope will differ depending on the observed portion, for example stomach or bowels, etc., and therefore the type of video-scope will also differ in accordance with the observed portion. The video-processor is connectable to a plurality of video-scopes including same type of video-scopes and different type of video-scopes, and one video-scope suitable for the observed portion is selectively connected to the video-processor. However, the video-processor has peculiar characteristics related to the signal process. Therefore, when directly using the series of scope-data read from the video-scope, improper signal processes including such examples as an improper white balance process, are occasionally performed due to the difference between the video-processor characteristics and the series of scope-data. Accordingly, after the series of scope-data is automatically set, data adjusting work is performed by the operator in accordance with the characteristics of the used video-processor.

When adjusting the data for all of the connectable video-scopes, the data adjusting work must be performed when connecting each new video-scope one at a time, so that a lot of time is wasted. Further, when plural video-processors are prepared, the data adjusting work must be performed for each video-processor, so that even more time is wasted.

### SUMMARY OF THE INVENTION

Therefore, an object of the present invention is to provide a video-processor and an electronic endoscope apparatus that effectively and properly performs the data setting process for the video-processor connectable to a plurality of video-scopes.

A video-processor according to the present invention, which is connectable to a plurality of video-scopes, has a memory, an adjusted scope-data setter, and an automatic adjustment scope-data setter. The memory is capable of storing plural series of initial scope-data associated with a signal process. The plural series of scope-data correspond to the plurality of video-scopes, and data values in each series of scope-data are set in accordance with a corresponding video-scope. For example, the R and B gain data relating to a white balance process, the delay time data, or the CCD gain data is included in each series of scope-data. The signal process is performed in accordance with the series of scope-data corresponding to the connected video-scope.

The adjusted scope-data setter sets manually adjusted scope-data, which is modified specific scope-data, in a selected series of initial scope-data corresponding to a selected video-scope among the plurality of video-scopes. The specific scope-data is modified in accordance with the data adjusting work carried out by the operator for the selected video-scope. For example, any connected video-scope is selected to perform the data adjusting work. The signal process is performed in accordance with the manually adjusted scope-data.

When plural video-scopes are consecutively connected to the video-processor and the data adjusting work is performed by the operator for some of the video-scopes, the following occurs when each new video-scope is attached. The automatic adjustment scope-data setter changes specific scope-data to automatically adjusted scope-data. The scope-data is included in a series of initial scope-data corresponding to a newly connected video-scope, and correspond to manually adjusted scope-data included in other series of initial scope-data, which corresponds to a given video-scope except for the recently connected video-scope. The signal process is performed in accordance with the altered series of scope-data corresponding to the connected video-scope. Then, the automatic adjustment scope-data setter calculates the automatically adjusted scope-data on the basis of at least one manually adjusted scope-data and at least one specific initial scope-data corresponding to the at least one manually adjusted scope-data. The at least one manually adjusted scope-data is set in accordance with the data adjusting work for at least one selected video-scope.

An electronic endoscope apparatus according to another aspect of the present invention is an apparatus capable of setting data associated with a signal process of an electronic endoscope apparatus. The electronic endoscope apparatus has a memory, an adjusted scope-data setter, an automatic adjustment scope-data setter, and a signal processor. The memory is capable of storing plural series of scope-data associated with a signal process. Data values in each series of scope-data are set in accordance with a corresponding video-scope among a plurality of video-scopes. The signal processor performs the signal process in accordance with a series of initial scope-data corresponding to a connected video-scope. The adjusted scope-data setter sets manually adjusted scope-data, which is modified specific scope-data in a selected series of initial scope-data corresponding to a selected video-scope among the plurality of video-scopes. The specific scope-data is modified in accordance with data adjusting work for the selected video-scope. The automatic adjustment scope-data setter changes scope-data to automatically adjusted scope-data. The scope-data is included in a series of initial scope-data corresponding to a recently connected video-scope. The signal process is performed in accordance with the automatically adjusted scope-data. The automatic adjustment scope-data setter calculates the automatically adjusted scope-data on the basis of at least one manually adjusted scope-data, which is set in accordance with the data adjusting work for at least one selected video-scope, and at least one specific initial scope-data corresponding to the at least one manually adjusted scope-data.

### BRIEF DESCRIPTION OF THE DRAWINGS

The present invention will be better understood from the description of the preferred embodiment of the invention set fourth below together with the accompanying drawings, in which:

FIG. 1 is an electronic endoscope apparatus according to the present embodiment.

FIG. 2 is a view showing a table of plural series of scope-data associated with the signal process.

FIG. 3 is a view showing a main routine associated with main processes of the video-processor.

FIG. 4 is a view showing a subroutine associated with the keyboard operation including the data adjusting work.

FIG. 5 is a view showing a subroutine for setting manually adjusted scope-data and calculating a scope-data ratio and an convergence ratio.

FIG. 6 is a view showing a subroutine associated with the connection of a video-scope.

FIG. 7 is a view showing a subroutine for setting automatically adjusted scope-data.

### DESCRIPTION OF THE PREFERRED EMBODIMENTS

Hereinafter, the preferred embodiment of the present invention is described with reference to the attached drawings.

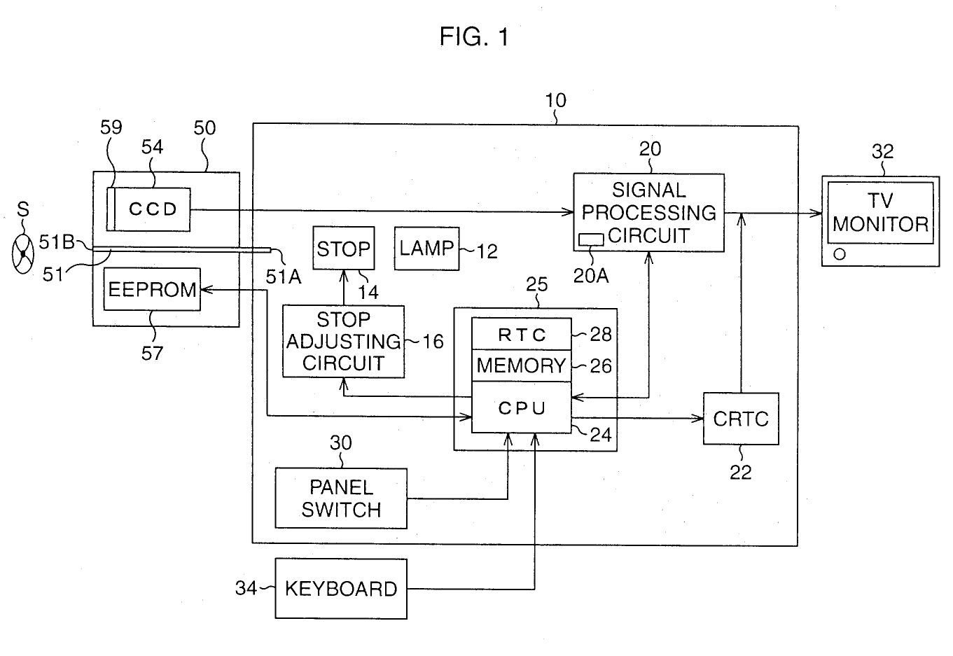

FIG. 1 is an electronic endoscope apparatus according to the present embodiment. The electronic endoscope apparatus has a video-scope 50 with a CCD (Charge-Coupled Device) 54 and a video-processor 10 that processes image signals fed from the video-scope 50. The video-scope 50 is detachably connected to the video-processor 10, and further the video-processor 10 is connected to a TV monitor 32 and keyboard 34.

When a lamp switch provided on the video-processor 10 (not shown) is turned ON, light is emitted from a lamp 12 and is directed toward an incident surface 51A of a fiber-optic bundle 51 via a collecting lens (not shown). The fiber-optic bundle 51, provided through the video-scope 50, directs the light to the distal end of the video-scope 50. The light passing through the fiber-optic bundle 51 exits from an end surface 51B of the fiber-optic bundle 51, and is emitted toward a subject S via a diffusion lens (not shown), so that the subject S is illuminated.

The light reflected on the subject S passes through an objective lens (not shown) and reaches the CCD 54, so that the subject image S is formed on a photo-sensor area of the CCD 54. For the color imaging process, in this embodiment, an on-chip color filter method using an on-chip color filter is applied. A color filter 59, checkered by four color elements of Yellow (Y), Magenta (Mg), Cyan (Cy), and Green (G), is arranged on the photo-sensor area of the CCD 54 such that the four color elements are opposite to the pixels arranged in the photo-sensor area. Image signals, corresponding to light passing through the color filter 59, are generated in the CCD 54 by the photoelectric transform effect. The generated color image signals are composed of plural color signal components. Then, one field worth of image signals is read from the CCD 54 at regular time intervals in accordance with the so called “color difference line sequential system”. In this embodiment, the NTSC standard is used as the color TV standard, accordingly, one field worth of image signals is read from the CCD 54 at 1/60 second time intervals, and then fed to a signal processing circuit 20.

The signal processing circuit 20 has an amplifier for amplifying the image signals read from the CCD 54, a separating circuit for separating the image signals into initial luminance signals and initial chrominance signals, an R, G, and B matrix circuit for generating primary color signals composed of Red (R), Green (G), and Blue (B) color element signals from the initial luminance and chrominance signals, a white balance adjusting circuit for adjusting the ratio of the R, G, B signals, a delay processing circuit for performing the delay process, and a color -matrix circuit for generating luminance signals and color difference signals (all not shown) and so on. Various processes are performed for the image signals in the signal processing circuit 20, so that video signals, such as NTSC composite signals, S-video signals, and R, G, B component signals, are generated and output to the monitor 32. Thus, the subject image is displayed on the monitor 32. Clock pulses are output from a timing control circuit (not shown) to each circuit in the video-processor 10, and synchronizing signals to be interleaved in the video signals are fed from the timing control circuit to the signal processing circuit 20.

A CPU (Central Processing Unit) 24 in a system control circuit 25 controls the video-processor 10 and outputs control signals and data associated with the signal process to the signal processing circuit 20 that is constructed as an IC chip. A program associated with an automatic data setting process is stored in a ROM (not shown) provided in the system control circuit 25. The video-scope 50 has an EEPROM (Electronic Erasable Programmable ROM) 57, and data corresponding to the characteristics of the video-scope 50, which include a series of data associated with the signal process (hereinafter, called the “series of scope-data”) , is stored in the EEPROM 57. When the video-scope 50 is connected to the video-processor 10, the series of scope-data stored in the EEPROM 57 is transmitted to the video-processor 10 and is temporarily stored in a memory 26. Then, a part of the series of scope-data is transmitted to a register 20A in the signal processing circuit 20 via the CPU 24. The register 20A is capable of storing plural scope-data associated with the signal process. The signal processing circuit 20 processes the image signals in accordance with data stored in the register 20A.

A panel switch 30 for setting a base luminance level is provided on the front panel of the video-processor 10. When the keyboard 34 is operated by the operator to display character information, such as a patient's information, the operation signal is fed to the CPU 24. The CPU 24 outputs control signals to a CRTC (CRT Controller) 22 in accordance with the operation signal, and character signals corresponding to the operation signal are output from the CRTC 22 and then superimposed into the video signals, so that the character information is displayed on the monitor 32 with the subject image. Data associated with the date and time is read from a RTC (Real Time Clock) 28, and character signals corresponding to the present date and time are output from the CRTC 22.

A stop 14 is provided between the incident surface 51A and the collecting lens to adjust an amount of light illuminating the subject S, and it opens and closes by using a motor (not shown). A stop adjusting circuit 16 controls the stop 14 such that the brightness of the subject image on the monitor 32 is maintained at a proper brightness.

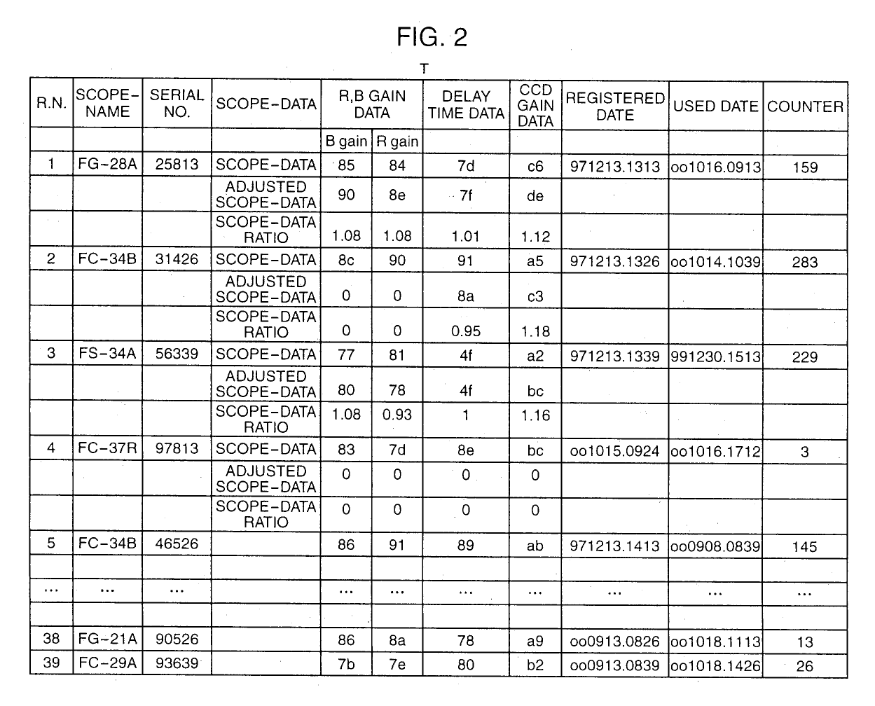

FIG. 2 is a view showing a table (hereinafter, called “table T”) of plural series of scope-data associated with the signal process.

As shown in FIG. 2, plural series of scope-data are stored in the memory 26. In this embodiment, 39 video-scopes are connectable to the video-processor 10 regardless of whether they are from the same types of video-scopes or the different types of video-scopes. Each series of scope-data is stored in an EEPROM 57 in a corresponding video-scope 50 in advance, and each series of initial scope-data is read from the corresponding EEPROM 57 and then stored in the memory 26. As each of the 39 video-scopes is connected to the video-processor 10 in order, the plural series of scope-data shown in FIG. 2 is registered in the memory 26 in order. During the register, a register number [1], [2], [3], . . . , [39] is assigned to each of the connected video-scopes to discriminate the plural video-scopes. A scope-name is assigned to each connected video-scope on the basis of the observed portion.

A part of the series of scope-data, such as R, B gain data associated with the white balance process, delay time data, and CCD gain data, is shown in the table T.

The values of initial scope-data are different between the different types of video-scopes, and further are different between the same types of video-scope. Namely, data values in each series of initial scope-data are set in accordance with the characteristics of the corresponding video-scope. However, the proper values of the R, B gain data, the delay time data, and the CCD gain data vary with the characteristics of the video-processor 10. Therefore, as described later, while connecting a given video-scope, data adjusting work that adjusts specific scope-data, such as the R, B gain data, to scope-data suitable for the characteristics of the video-processor 10, is performed by the operator. Herein, only three scope-data, namely, the R, B gain data, the delay time data, and the CCD gain data in each series of scope-data are adjusted. Specific scope-data modified by the data adjusting work is hereinafter designated as “manually adjusted scope-data”.

Further, a ratio of the initial specific scope-data and the modified scope-data (hereinafter, called “scope-data ratio”) is calculated to perform an automatic data adjusting process described later. The adjusted scope-data and the scope-data ratio are stored at given addresses in the memory 26. Note that, when the data adjusting work is not performed for specific scope-data, the values of the manually adjusted scope-data and the specific scope-data ratio are respectively set to “0”.

In addition to the above data, a registered date, a used date indicating the last used date, and a counter indicating the number of used times, are stored in the memory 26.

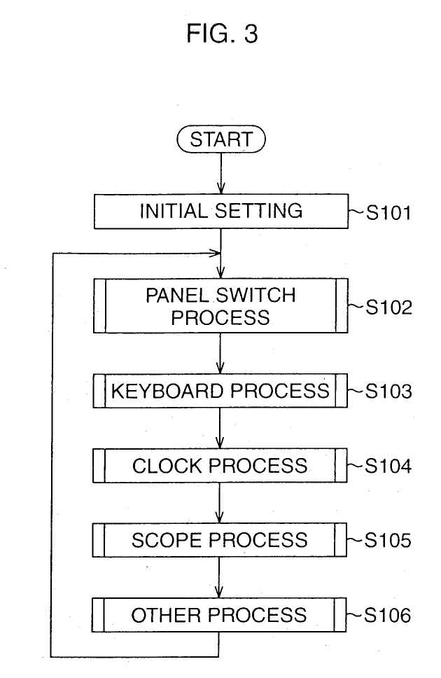

FIG. 3 is a view showing a main routine performed in the CPU 24. When electric power is supplied to the video-processor 10, the main routine is started.

In Step S101, the initial setting of the CPU 24 and the setting of parameters are performed. In Step S102, a process associated with the panel switch 30 is performed. In Step S103, a process associated with the keyboard 34 is performed. In Step S104, a clock process that displays a date and time by reading the date and time data from the RTC 28 is performed. In Step S105, as described later, a process associated with the video-scope 50 is performed. In Step S106, other processes such as a light-amount adjustment, are performed. Steps S102 to S106 are repeatedly performed until the electric power is turned OFF.

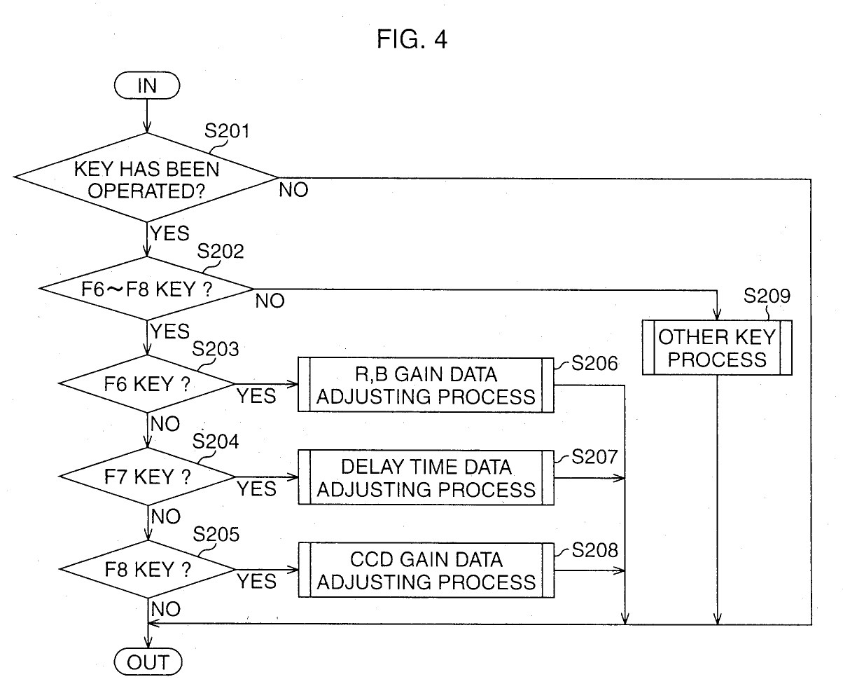

FIG. 4 is a view showing a subroutine of Step S103 in FIG. 3. The data adjusting work is performed using the keyboard 34.

In Step S201, it is determined whether the keyboard 34 is operated by the operator. When it is determined that the keyboard 34 is not operated, the subroutine is terminated. On the other hand, when it is determined that the keyboard 34 is operated, the process goes to Step S202. Note that, since Step S201 is performed before the operation of the keyboard 34 immediately after the electric power is turned ON, the process does not go to Step S202 in this case.

In Step S202, it is determined whether one of the function keys F6 to F8 has been operated to adjust the value of the initial specific scope-data, which is read from the connected video-scope, to a proper value. In this embodiment, the R, B gain data associated with the white balance process is adjusted by operating the function key F6, the delay time data is adjusted by operating the function key F7, and the CCD gain data is adjusted by operating the function key F8. When it is determined that a key other than the function keys F6 to F8 has been operated, the process goes to Step S209, wherein a given process corresponding to the operated key is performed. On the other hand, when it is determined that one of the function keys F6 to F8 has been operated, the process goes to Step S203.

In Step S203, it is determined whether the function key F6 is operated. When it is determined that the function key F6 is operated, the process goes to Step S206. In Step S206, R, B gain data associated with the white balance process is adjusted, and the modified scope-data, the value of which is changed to a proper value, is set as the “manually adjusted scope-data”. In this embodiment, the data adjusting work is performed for the connected video-scope. Namely, the connected video-scope is selected for performing the data adjusting work. After Step S206 is performed, the subroutine is terminated. On the other hand, when it is determined that the function key F6 has not been operated, the process goes to Step S204.

In Step S204, it is determined whether the function key F7 has been operated. When it is determined that the function key has been operated, the process goes to Step S207. In Step S207, the delay time data is adjusted, the modified delay time data is set as the “manually adjusted scope-data”. After Step S207 is performed, the subroutine is terminated. On the other hand, when it is determined that the function key F7 has not been operated, the process goes to Step S205.

In Step S205, it is determined whether the function key F8 has been operated. When it is determined that the function key F8 has been operated, the process goes to Step S208. In Step S208, the CCD gain data is adjusted and the modified CCD gain data is set as the “manually adjusted scope-data”. After Step S208 is performed, the subroutine is terminated. On the other hand, when it is determined that the function key F8 has not been operated, the subroutine is directly terminated. Note that, the operator adjusts the scope-data such as the CCD gain data while observing the monitor 32

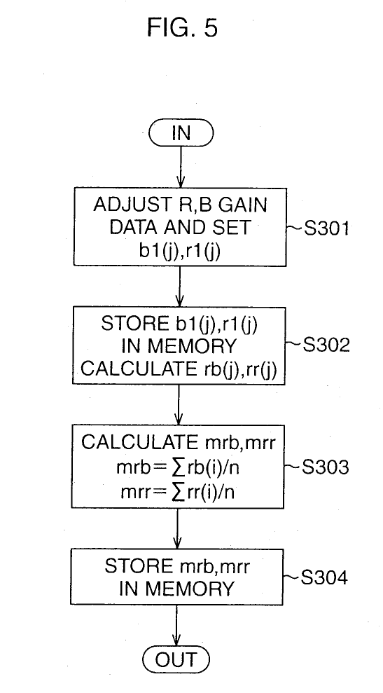

FIG. 5 is a view showing a subroutine of Step S206 in FIG. 4.

In Step S301, the R, B gain data is adjusted in accordance with the operation of the function key F6, and the modified R, B gain data is set as the “adjusted specific scope-data”. Hereinafter, the original R, B gain data before the data adjusting work is designated as “r0(j), b0(j)”, the adjusted R, B gain data is designated as “r1(j), b1(j)”. Namely, the “r0(j), b0(j)” respectively correspond to the “initial scope-data” and the “r1(j), b1(j)” respectively correspond to the “manually adjusted scope-data”. Note that, a variable “j” indicates a register number of the selected video-scope for the data adjusting work, namely, the connected video-scope, and the register number is set to a register number variable “vr”. As described above, since Steps S202 to S209 shown in FIG. 4 are skipped and Step S105 shown in FIG. 3 is performed immediately after the electric power is turned ON, when performing Step S301, the series of initial scope-data has been read from the connected video-scope and is stored in the memory 26. Consequently, the data adjusting work corresponding to the connected video-scope can be performed in the subroutine in FIG. 5.

In Step S302, the manually adjusted scope-data “r1(j), b1(j)” are stored at given address in the memory 26. Further, scope-data ratios “rr(j), bb(j)”, which are respectively ratios of “r1(j) , b1+ (j)” to “r0(j) , b0(j)”, are calculated in accordance with the following formulae.

rr(j)=r1(j)/r0(j) (1)

rb(j)=b1(j)/b0(j) (2)

The scope-data ratios “rr(j), rb(j)” are stored at their respective addresses in the memory 26.

In Step S303, to effectively utilize plural scope-data ratios that have been calculated in accordance with the adjusting work for the previously connected video-scopes, averages of the calculated scope-data ratios “mmr” and “mmb” (hereinafter, respectively called “convergence ratio”) are respectively calculated in accordance with the following formulae.

mrr=Σrr(i)/n (3)

mrb=Σrb(i) /n (4)

Herein, the variable “i” indicates the register number of the video-scope, the scope-data ratio of which is used for obtaining the convergence ratios “mrr, mrb”. The “Σ” indicates the total sum of the scope-data ratios corresponding to the R, B gain data that have been calculated, whereas the “n” indicates the number of calculated scope-data ratios. For example, when the video-scopes “[1] to [10]” are connected to the video-processor 10 in order and the adjusted scope-data has been set for each connected video-scope in accordance with the data adjusting work, the “n” is 10, and the convergence ratios “mrr, mrb” are calculated by respectively dividing the total sum of “rr(1) to rr(10)” and “bb(1) to bb(10)” by “n” (=10). In Step S304, the convergence ratios “mrr, mrb” are stored at their respective given addresses in the memory 26. After Step S304 is performed, the subroutine is terminated.

Similarly, In Steps S207 and S208 shown in FIG. 4, the scope-data ratios corresponding to the delay time data and the CCD gain data are respectively set and convergence ratios are calculated on the basis of the plural calculated scope-data ratios.

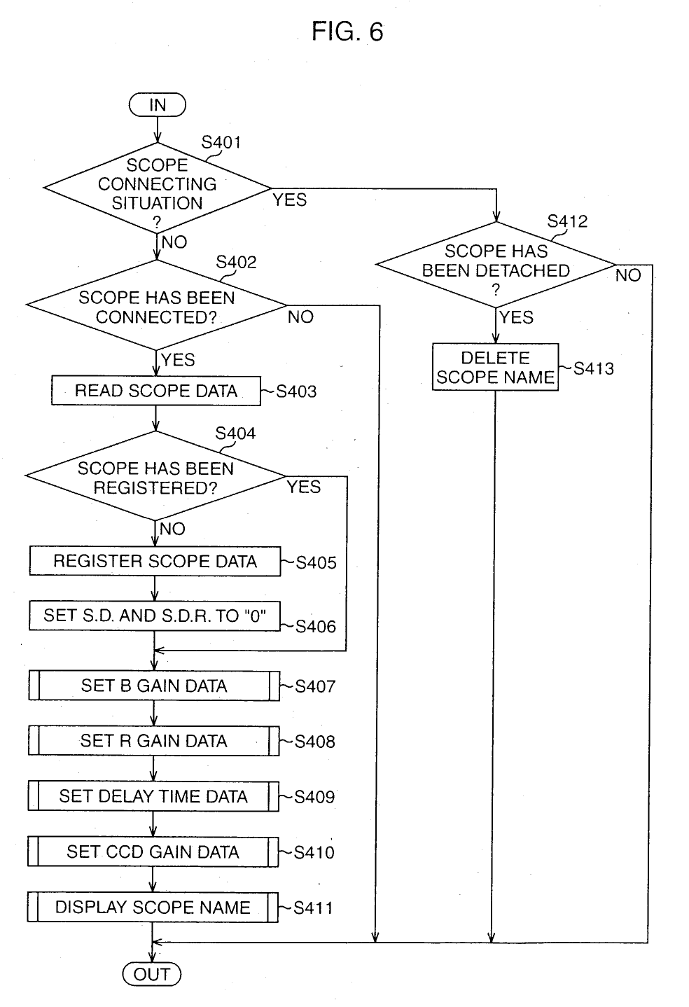

FIG. 6 is a view showing a subroutine performed in Step S105 in FIG. 3.

In Step S401, it is determined whether a given video-scope among the plurality of video-scopes is connected to the video-processor 10. When it is determined that the video-scope is not connected to the video-processor 10, the process goes to Step S412, wherein it is determined whether the video-scope has been detached from the video-processor 10. When it is determined that the video-scope has not been detached from the video-processor 10, the subroutine is terminated. On the other hand, when it is determined that the video-scope has been detached from the video-processor 10, the process goes to Step S413, wherein the scope-name is deleted from the monitor 32. After Step S413 is performed, the subroutine is terminated.

On the other hand, when it is determined in Step S401 that the video-scope is not connected to the video-processor 10, the process goes to Step S402. In Step S402, it is determined whether a video-scope has been newly connected to the video-processor 10. When it is determined that a new video-scope has not been connected to the video-processor 10, the subroutine is terminated. On the other hand, when it is determined that the video-scope has been newly connected to the video-processor 10, the process goes to Step S403, wherein the series of initial scope-data is read from the EEPROM 57 in the connected video-scope. Then, in Step S404, it is determined whether the connected video-scope 50 has been registered. Herein, a serial number of the read series of scope-data is searched from the serial numbers that are stored in the memory 26 so that it is determined whether the register has finished. When it is determined that the connected video-scope has been registered, the process shifts to Step S407. On the other hand, when it is determined that the connected video-scope has not been registered, the process goes to Step S405.

In Step 405, address in the memory 26, which is capable of storing the read series of scope-data is searched for. When a given address where the series of scope-data corresponding to the connected video-scope can be stored, is found, the register number corresponding to the found address is set to the register variable “vr”. The series of initial scope-data including the scope-name, the serial number, the R, B gain data, delay time data, and the CCD gain data, is read from the EEPROM 57 in the connected video-scope and is written at the address. On the other hand, when the read series of scope-data cannot be written at any address, the registered date is referred to and the register number of the oldest registered date is set to the register variable “vr”. Then, the read series of scope-data is written in an address corresponding to the register number of the oldest registered date. In Step S406, both of the values of the adjusted scope-data and the scope-data ratio for the written series of scope-data are set to “0”. The value “0” indicates scope-data that has not been modified by the data adjusting work.

In Step S407, as described later, the B gain data associated with the white balance process is set in the register 20A in the signal processing circuit 20. In Step S408, the R gain data is set in the register 20A in the signal processing circuit 20. In Step S409, the delay time data is set in the register 20A in the signal processing circuit 20. In Step S410, the CCD gain data is set to the register 20A in the signal processing circuit 20. In Step S411, the scope-name of the connected video-scope is displayed on the monitor 32. After Step S411 is performed, the subroutine is terminated.

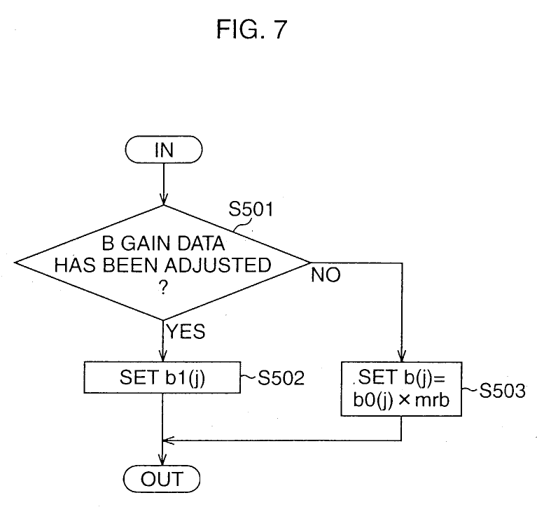

FIG. 7 is a view showing a subroutine of Step S407 in FIG. 6, in which the automatic adjusting process is performed.

In Step S501, it is determined whether the adjusted scope-data of the B gain data “b1(j)” is “0”. Namely, it is determined whether the B gain data corresponding to the connected video-scope has been adjusted in accordance with the data adjusting work. When it is determined that the “b1(j)” is not “0”, namely, the B gain data has been adjusted, the process goes to Step S502, in which the value of the B gain data “b1(j)” is directly set in the register 20A in the signal processing circuit 20 as the “adjusted scope-data”. On the other hand, when it is determined that the B gain data is “0”, namely, the B gain data has not been manually adjusted, the process goes to Step S503.

In Step S503, the B gain data “b (j)” is calculated in accordance with the following formula. Herein, the scope-data “b0(j)” is the initial specific scope-data that corresponds to the connected video-scope and is subjected to the automatic data adjusting process. The scope-data “b (j)” is designated as an “automatic adjustment scope-data”.

b(j)=b0(j)×mrb (5)

The automatic adjustment scope-data of the B gain data “b (j)” is set to the register 20A in the signal processing circuit 20.

The R gain data is adjusted at Step S408 in FIG. 6 similarly to the B gain data shown in FIG. 7. Namely, when the data adjusting work has not been performed for the R gain data, the automatic adjustment scope-data of R gain data “r (j)” is calculated in accordance with the following formula.

r(j)=r0(j)×mrr (6)

The R gain data r (j) is set in the register 20A in the signal processing circuit 20 as the “automatically adjusted scope-data”. A similar process is performed for the delay time data, and the CCD gain data.

In this way, in this embodiment, the video-processor 10 is connectable to the plurality of video-scopes. The memory 26 is capable of storing 39 series of scope-data corresponding to 39 video-scopes, and the signal processing circuit 20 processes image signals in accordance with the series of scope-data corresponding to the connected video-scope. The data adjusting work is performed by the operator for specific scope-data in the series of initial scope-data corresponding to the connected video-scope, for example, the R, B gain data, the delay time data, or the CCD gain data. At this time, the manually adjusted scope-data such as “r1(j) and b1(j)” are set, and the convergence ratios such as “mrb and mrr” are calculated. Then, specific scope-data (given scope-data corresponding to previously manually adjusted scope-data) in the series of scope-data corresponding to the newly connected video-scope, is changed to the automatically adjusted scope-data such as “b(j) and/or r(j)” on the basis of the convergence ratios when the data adjusting work has not been performed for the initial specific scope-data. The automatically adjusted scope-data such as “r(j) and/or b(j)” is set in the register 20A in the signal processing circuit 20. On the other hand, when the data adjusting work has performed for the initial specific scope-data, the manually adjusted scope-data such as “r1(j) ,b1(j)” is directly set in the register 20A in the signal processing circuit.

To set the proper automatic adjustment scope-data, the automatic adjustment scope-data maybe calculated on the basis of only some convergence ratios corresponding to the same type of video-scope for observing, for example, a stomach or bowels, in place of all of the average ratios that have been calculated.

The automatic adjusting process may be performed on the basis of a difference between the initail scope-data and the adjusted scope-data in place of the ratio of the adjusted scope-data to the initial scope-data. For example, the B gain data may be calculated in accordance with the following formula.

b(j)=f((b0(k1), . . . , b0(km)), (b1(k1), . . . , b1(km))) (7)

The function “f” indicates a function for obtaining the B gain data “b(j)”, the variable “k1, k2, . . . , or km” indicates the register number. The “b0(k1) ,b0(k2), . . . , or b0(km)” indicates unadjusted initial scope-data, whereas the “b1(k1) ,b1(k2), . . . , or b1(km)” indicates the adjusted scope-data.

Concretely speaking, the R, B gain data may be automatically adjusted on the basis of the following formulae. Note that, “r0(j) and b0(j)” indicate the initial scope-data, “r1(j) and b1(j) ” indicate the adjusted scope-data, “dr(i) and db(i) ” indicate the difference between the initial scope-data and the adjusted scope-data, and “mdr and mdb” indicate an average of the difference. Further, the variable “i” indicates the register number, which is used for calculating the automatic adjustment scope-data “r(j) and b(j)”, the variable “j” indicates the register number of the connected video-scope, and “n” indicates the number of the scope-data differences that have been calculated.

dr(i)=r1(i)−r0(i) (8)

db(i)=b1(i)−b0(i) (9)

mdr=Σdr(i)/n (10)

mdb=Σdb(i)/n (11)

r(j)=r0(j)+mdr (12)

b(j)=b0(j)+mdb (13)

Finally, it will be understood by those skilled in the art that the foregoing description is of preferred embodiments of the device, and that various changes and modifications may be made to the present invention without departing from the spirit and scope thereof.

The present disclosure relates to subject matters contained in Japanese Patent Application No. 2002-051068 (filed on Feb. 27, 2002) which is expressly incorporated herein, by reference, in its entirety.

1. A video-processor in an electronic endoscope apparatus, which is connectable to a plurality of video-scopes, comprising:
a memory that is capable of storing plural series of initial scope-data associated with a signal process, data values in each series of scope-data being set in accordance with a corresponding video-scope among the plurality of video-scopes, the signal processing being performed in accordance with a series of initial scope-data corresponding to a connected video-scope;
an adjusted scope-data setter that sets manually adjusted scope-data, which is modified specific scope-data in a selected series of initial scope-data corresponding to a selected video-scope among the plurality of video-scopes, the specific scope-data being modified in accordance with data adjusting work for the selected video-scope; and
an automatic adjustment scope-data setter that changes given scope-data to automatically adjusted scope-data, the given scope-data being included in a series of initial scope-data corresponding to a recently connected video-scope, the signal process being performed in accordance with the automatically adjusted scope-data,
wherein said automatic adjustment scope-data setter calculates the automatically adjusted scope-data on the basis of at least one manually adjusted scope-data, which is set in accordance with the data adjusting work for at least one selected video-scope, and at least one initial specific scope-data corresponding to the at least one manually adjusted scope-data.

2. The video-processor of claim 1, wherein said automatic adjustment scope-data setter calculates the automatically adjusted scope-data on the basis of a ratio of the at least one manually adjusted scope-data to the at least one initial specific scope-data.

3. The video-processor of claim 2, wherein said automatic adjustment scope-data setter calculates the automatically adjusted scope-data on the basis of an average of plural ratios, each of which is calculated on the basis of a manually adjusted scope-data and a initial specific scope-data, which are related to each other.

4. The video-processor of claim 1, wherein said automatic adjustment scope-data setter calculates the automatically adjusted scope-data on the basis of a difference between the at least one manually adjusted scope-data and the at least one specific scope-data.

5. The video-processor of claim 4, wherein said automatic adjustment scope-data setter calculates the automatically adjusted scope-data on the basis of an average of plural differences, each of which is calculated on the basis of a manually adjusted scope-data and a initial specific scope-data, which are related to each other.

6. The video-processor of claim 1, further comprising a manual adjustment situation determiner that determines whether the given scope-data has been modified in accordance with the data adjusting work for the selected video-scope, wherein said automatic adjustment scope-data setter dose not change the given scope-data when the given scope-data has been modified.

7. The video-processor of claim 1, wherein each of said plurality of video-scopes has a scope-memory for storing a corresponding series of initial scope-data, each of the plural series of scope-data being fed to said memory when a corresponding video-scope is connected to the video-processor.

8. A computer program product for setting data associated with a signal process of an electronic endoscope apparatus with a video-processor, said computer program product comprising:
a storing processor that stores data associated with a signal process in a memory, said memory being capable of storing plural series of initial scope-data associated with the signal process, data values in each series of scope-data being set in accordance with a corresponding video-scope among said plurality of video-scopes, the signal processing being performed in accordance with a series of initial scope-data corresponding to a connected video-scope;
an adjusted scope-data setter that sets manually adjusted scope-data, which is modified specific scope-data in a selected series of initial scope-data corresponding to a selected video-scope among said plurality of video-scopes, the specific scope-data being modified in accordance with data adjusting work for the selected video-scope; and
an automatic adjustment scope-data setter that changes given scope-data to automatically adjusted scope-data, the given scope-data being included in a series of initial scope-data corresponding to a recently connected video-scope, the signal process being performed in accordance with the automatically adjusted scope-data,
wherein said automatic adjustment scope-data setter calculates the automatically adjusted scope-data on the basis of at least one manually adjusted scope-data, which is set in accordance with the data adjusting work for at least one selected video-scope, and at least one initial specific scope-data corresponding to the at least one adjusted scope-data.

9. An electronic endoscope apparatus comprising:
a memory that is capable of storing plural series of scope-data associated with a signal process, data values in each series of scope-data being set in accordance with a corresponding video-scope among a plurality of video-scopes;
a signal processor that performs the signal process in accordance with a series of initial scope-data corresponding to a connected video-scope,
an adjusted scope-data setter that sets manually adjusted scope-data, which is modified specific scope-data in a selected series of scope-data corresponding to a selected video-scope among said plurality of video-scopes, the specific scope-data being modified in accordance with data adjusting work for the selected video-scope;
an automatic adjustment scope-data setter that changes given scope-data to automatically adjusted scope-data, the given scope-data being included in a series of initial scope-data corresponding to a recently connected video-scope, the signal processing being performed in accordance with the automatically adjusted scope-data;
wherein said automatic adjustment scope-data setter calculates the automatically adjusted scope-data on the basis of at least one adjusted scope-data, which is set in accordance with the data adjusting work for at least one selected video-scope, and at least one initial specific scope-data corresponding to the at least one manually adjusted scope-data.
